(19) United States
(12) Patent Application Publication
(10) Pub. No.: US 2017/0091441 A1
(43) Pub. Date: Mar. 30, 2017

(54) PASSWORD INTERPOSER

(71) Applicant: International Business Machines Corporation, Armonk, NY (US)

(72) Inventors: John Elbert Moore, JR., Brownsburg, IN (US); Jeffrey Kevin Price, Austin, TX (US); Robert Richard Wentworth, Round Rock, TX (US); Stanley Carroll Wood, Round Rock, TX (US)

(21) Appl. No.: 14/869,052

(22) Filed: Sep. 29, 2015

(51) Int. Cl. G06F 21/46

(52) U.S. Cl. CPC G06F 21/46

(57) ABSTRACT

A method includes a user device receiving password interposer instructions to form a password interposer program; initiating a first time setup for the password interposer program within the user device to create a random salt value after password interposer instructions initiation and store the random salt value within the user device; the user device prompting a user to enter first information and a simple password; and the password interposer program concatenating using the user's first information and the simple password, and the stored random salt value to be used as feeds in generating a complex password

### BACKGROUND

The present invention relates to creating complex passwords, and more specifically, to using stored salt values and simple passwords to create complex passwords.

Password security has become a ubiquitous feature across the Internet and enterprise, and even home IT infrastructures. Typical people in the modern world have userids and passwords for dozens of systems. These systems have varying requirements for password length and complexity. It is common for people to use simple passwords and/or re-use the same userid and password or slight variations of the same across many different systems. Simple passwords are surprisingly easy for automated systems to guess. Even complex passwords are easily broken when re-used across many different systems.

The current state of the art includes password re-use, 2-part authentication, password wallets, use of pass phrases, and mental transformations or schemes for remembering multiple passwords.

Password re-use—many people use the same password or a small set of passwords across all sites and applications that they use. One problem with this approach are that people tend to use simple passwords, which are easy for automated systems to guess. Another problem is that hackers can compromise one site and capture or break the common password, they can use it to leap frog to user's accounts on other sites. In some cases users will use one password for “trivial” sites like games and social networks and another for things related to commerce or finance. This is only marginally better than using a single password on everything.

Use of pass phrases—some people use longer pass phrases which are more memorable than passwords. However many sites and applications do not support this, and longer phrases may not contain much more entropy than a password if they are made up of common words.

Password wallets/vaults—is a commonly used solution that can be really secure. In a well implemented password wallet, the user establishes a master password which is used to encrypt a small database or “wallet file.” This encrypted database contains a list of sites or applications where the user has an account, along with the username and a password. While the site passwords can be user set or reused, they are typically randomly generated per site by the password wallet application. The password wallet does not require any integration with the various sites, it simply generates, stores, and retrieves passwords. A password wallet can be backed up and most can be synchronized between multiple devices. A backup and/or sync operation must be performed any time a new account is added or a password changed.

Two-factor authentication with security tokens—this relies on both something a user knows (a password) and something the user have (a security token). A common element of this is a token that displays an ever changing series of numbers based on the current time. This requires the user to carry a dedicated device which has been synchronized with the site or application. It also requires significant integration with the site or application. In many cases it requires that the password be transmitted over the network. The loss or destruction of the single device effectively locks the user out of their account.

Biometric authentication—this relies on something users fingerprints, iris, facial features, etc., sometimes in combination with something they know or have. While biometric authentication is improving, it is still subject to lock out in the event that something about the user related to the biometric changes. For example, an eye or finger injury would affect an iris scan or finger print. Illness or weight fluctuations can change facial features. An attacker who manages to clone the physical aspect of the user (through a gelatin fingerprint mold, latex mask, etc.) is difficult to thwart because the user cannot readily change these aspects of themselves.

Mental transformations or schemes—these are mental algorithms which can be used to transform site or application names into unique passwords. These require the user to remember an algorithm rather than password. They create a tradeoff between the simplicity of the algorithm and the complexity of the passwords generated. This technique is difficult to master and therefore not widely used. The passwords generated are often subject to easy attack and once one is broken it may be easily used to leapfrog to other sites with automated guessing algorithms.

### SUMMARY

According to one aspect of the present invention, a method includes a user device receiving password interposer instructions to form a password interposer program; initiating a first time setup for the password interposer program within the user device to create a random salt value after password interposer instructions initiation and store the random salt value within the user device; the user device prompting a user to enter first information and a simple password; and the password interposer program concatenating the use of the user's first information and the simple password, and the stored random salt value to be used as feeds in generating a complex password.

According to another aspect of the present invention, a system Includes one or more processors, one or more computer-readable memories and one or more computer-readable, tangible storage devices; a user device operatively coupled to at least one of the one or more storage devices for execution by at least one of the one or more processors via at least one of the one or more memories, configured to receive password interposer instructions to form a password interposer program; an initiation module operatively coupled to at least one of the one or more storage devices for execution by at least one of the one or more processors via at least one of the one or more memories, configured to run a first time setup for the password interposer program within the user device to create a random salt value after password interposer instructions initiation and store the random salt value within the user device; a prompting module operatively coupled to at least one of the one or more storage devices for execution by at least one of the one or more processors via at least one of the one or more memories, configured to have the user device prompt a user to enter first information and a simple password; and a concatenating module operatively coupled to at least one of the one or more storage devices for execution by at least one of the one or more processors via at least one of the one or more memories, configured to concatenate the use of the user's first information and the simple password, and the stored random salt value to be used as feeds in generating a complex password

According to yet another aspect of the present invention, a computer program product includes one or more computer-readable storage medium, wherein the computer readable storage medium is not a transitory signal per se; program instructions, stored on at least one of the one or more storage medium, to cause a user device receive password interposer instructions to form a password interposer program; program instructions, stored on at least one of the one or more storage medium, to initiate a first time setup for the password interposer program within the user device to create a random salt value after password interposer instructions initiation and store the random salt value within the user device; program instructions, stored on at least one of the one or more storage medium, to prompt a user to enter first information and a simple password; and program instructions, stored on at least one of the one or more storage medium, to cause the password interposer program to concatenate the use of the user's first information and the simple password, and the stored random salt value to be used as feeds in generating a complex password

### BRIEF DESCRIPTION OF THE OF THE DRAWINGS

FIG. 1 illustrates an exemplary implementation according to an embodiment of the present invention.

FIG. 2 shows a flowchart according to an embodiment of the present invention.

FIGS. 3A and 3B show flowcharts according to embodiments of the present invention.

FIG. 4 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

Embodiments of the present invention generate a complex password on the fly each time a user needs to authenticate to a site or application. They use a stored random salt value, the name of the site or application, and a simple user entered password to generate the complex password. The complex password can be transferred to the application automatically, placed into a copy/paste buffer, or displayed for manual entry. The invention does not store the password but keeps it in memory only long enough to display or copy it.

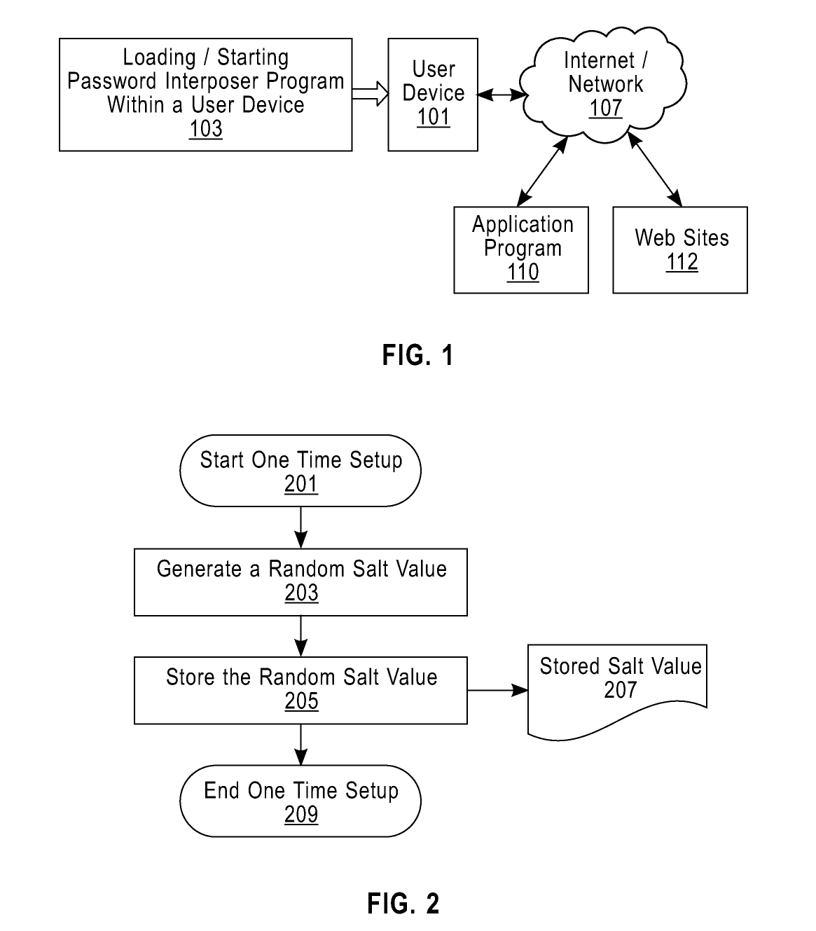

Now referring to FIG. 1, an exemplary implementation according to an embodiment of the present invention is depicted. A user device 101 is loaded with, or starts, a password interposer program 103. The user device 101 connects with the internet or business network 107 to gain access to either an application program 110 or web sites 112. To gain access to either the application program 110 or web sites 112, a user is required to input login information into the user's device 101. The specific information which is needed for login and the process for gaining access will be described hereafter. In short, the user device transforms a simple and memorable password into a longer, more complex password that is unique to the website or application.

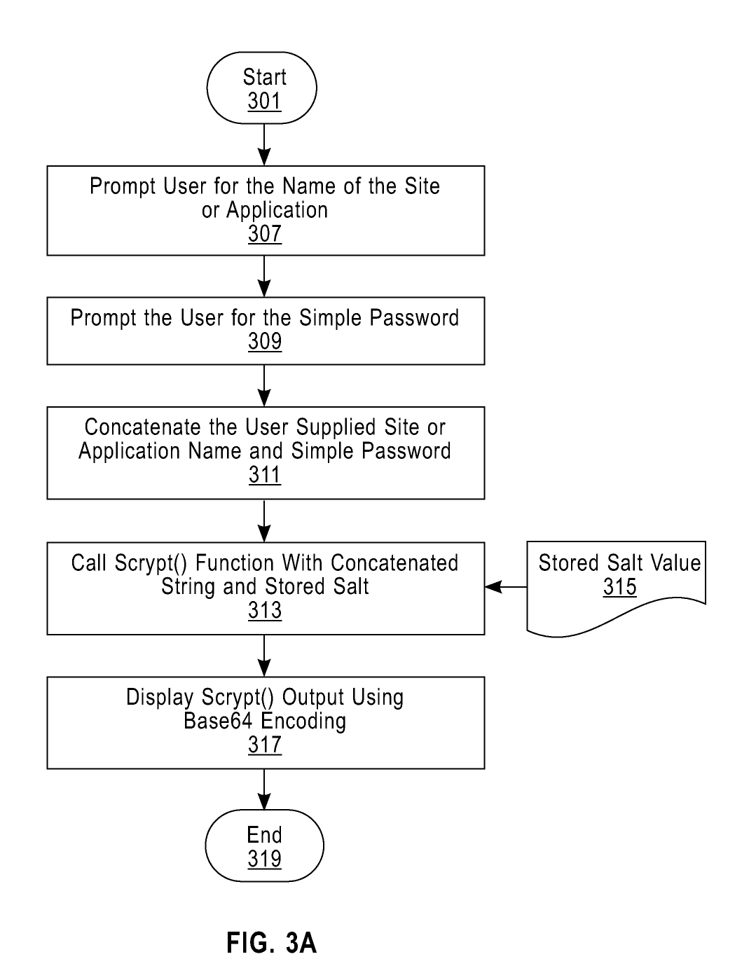

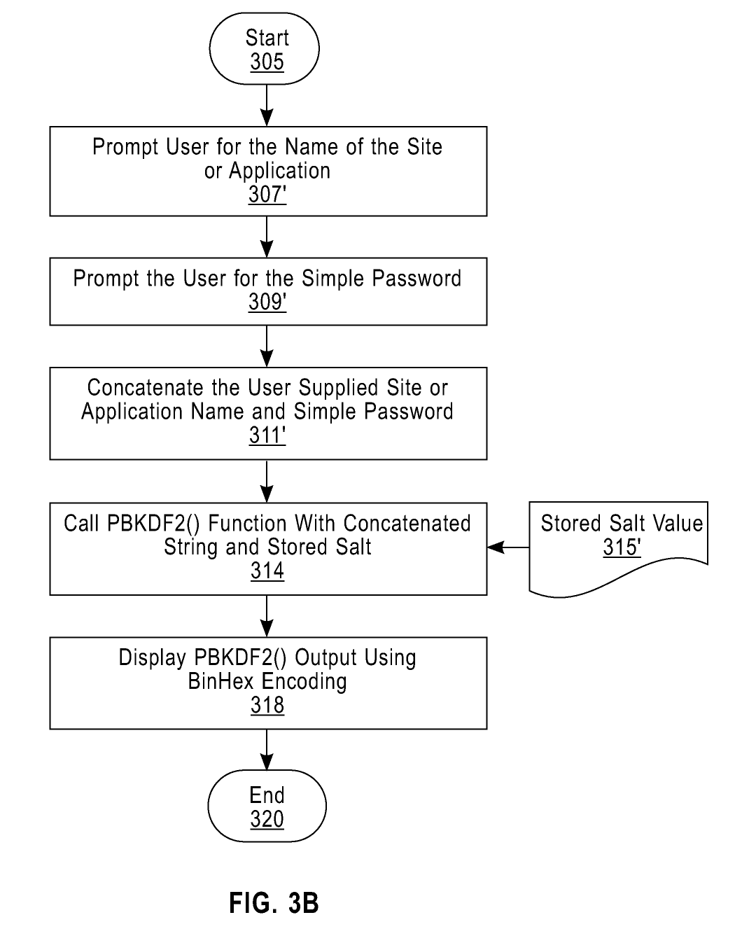

Referring to FIGS. 2 and 3A, shown is a process according to a first embodiment of the present invention. The process starts by initiating a one-time setup 201. The process then generate a random salt value 203 and stores the random salt value 205 into a salt value file 207. The one-time setup process then ends 209. When a user wishes to gain access or setup access to either the secured website or application program, the process starts 301 by prompting the user for the name or address of the secured website or application program 307. The user is then prompted to input a simple password 309. The simple password is something the user can easily remember. The process concatenates, uses, or joins the user's supplied secured website name (or address) or application program name and simple password 311. The process then calls up cryptographic function (such as in scrypt, which is a password-based key derivation algorithm) with the concatenated string and the stored salt value 315 to generate a complex password 313. The cryptographic (Passphrase, Salt, N, p, dkLen) function may use the following values to generate the complex password:
Passphrase: Usage of the user supplied site name and simple password;
Salt: Stored Random Salt;
N: Constant value like 2̂24;
p: Constant value like 2̂4;
dkLen: Constant value like 12 (random password length).

Still referring to FIG. 3A, the process displays the scrypt output, containing the complex password, using base64 encoding 317 then ends 319. This provides for the transformation of a simple and memorable password into a longer, more complex password that is unique to the website or application. The complex password can be used either upon a first use or returning to the website or reuse of the application. There will be times that the website and/or application program will require a password update due to security reasons. If this is the case the user just needs to re-run the setup process to create a new stored salt value. The user need not remember a new simple password. Of course, the generation of new complex password can be obtained by keeping the current salt value and using a new simple password. In either case, the complex password will be unique to that website or application program.

Referring now to FIG. 3B, shown is a process according to another embodiment of the present invention. When a user wishes to gain access or setup access to either the secured website or application program, the process starts 305 by prompting the user for the name or address of the secured website or application program 307′. The user is then prompted to input a simple password 309′. The simple password is something the user can easily remember. The process concatenates, uses, or joins the user's supplied secured website name (or address) or application program name and simple password 311′. The process then calls up a password based key derivation function (PBKDF)( ) function with the concatenated string and the stored salt value 315′ to generate a complex password 314. The PBKDF (PRF, Passphrase, Salt, c, dkLen) function may use the following values to generate the complex password:
PRF: Hash algorithm SHA-256;
Password: Usage of the user supplied site name and simple password;
Salt: Stored Random Salt;
c: Constant value like 2̂16;
dkLen: Constant value like 12 (random password length).

Still referring to FIG. 3B, the process displays the scrypt output, containing the complex password, using binhex encoding 318 then ends 320. This provides for the transformation of a simple and memorable password into a longer, more complex password that is unique to the website or application. The complex password can be used either upon a first use or returning to the website or reuse of the application. There will be times that the website and/or application program will require a password update due to security reasons. If this is the case the user just needs to re-run the setup process to create a new stored salt value. The user need not remember a new simple password. Of course, the generation of new complex password can be obtained by keeping the current salt value and using a new simple password. In either case, the complex password will be unique to that website or application program.

Other embodiments of the present invention may use different constants with the above functions or use different cryptographic hash functions. In addition symmetric ciphers may also be used with the user supplied simple password and web site/program application to encrypt the stored random salt value.

The embodiments of this invention may be in the form of a dedicated device or an application or modules that runs on devices like smartphones, tablets, laptop and desktop computers. The random salt value may be synchronized between instances of the invention and it does not change as accounts and passwords change, the password interposer of the present invention is convenient for multi-device use.

Yet an alternate embodiment of the present invention may store preference data for each site. This could be used to specify specific requirements about the password like a minimum or maximum length, restricted or required characters, etc. It could also potentially store a unique salt value for each site. The name of the site or application would be hashed to prevent someone who gained access to the invention from being able to extract a list of sites or applications where the user has accounts.

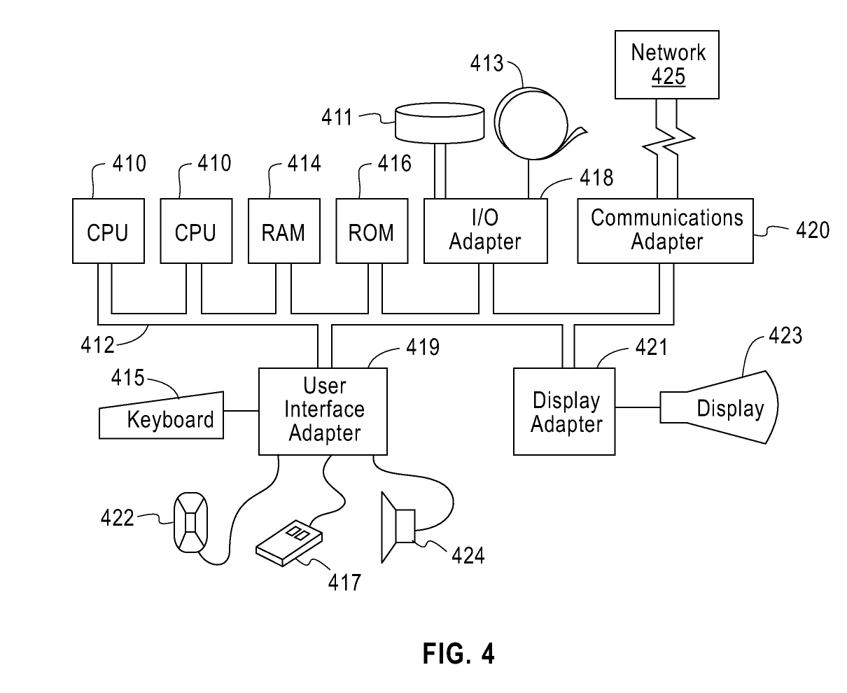

Referring now to FIG. 4, this schematic drawing illustrates a hardware configuration of an information handling/computer imaging system in accordance with the embodiments of the invention. The system comprises at least one processor or central processing unit (CPU) 410. The CPUs 410 are interconnected via system bus 412 to various devices such as a random access memory (RAM) 414, read-only memory (ROM) 416, and an input/output (I/O) adapter 418. The I/O adapter 418 can connect to peripheral devices, such as disk units 411 and tape drives 413, or other program storage devices that are readable by the system. The system can read the inventive instructions on the program storage devices and follow these instructions to execute the methodology of the embodiments of the invention. The system further includes a user interface adapter 419 that connects a keyboard 415, mouse 417, speaker 424, microphone 422, and/or other user interface devices such as a touch screen device (not shown) to the bus 412 to gather user input. Additionally, a communication adapter 420 connects the bus 412 to a data processing network 425, and a display adapter 421 connects the bus 412 to a display device 423 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
a user device receiving password interposer instructions to form a password interposer program;
initiating a first time setup for the password interposer program within the user device to create a random salt value after password interposer instructions initiation and store the random salt value within the user device;
the user device prompting a user to enter first information and a simple password; and
the password interposer program concatenating the use of the user's first information and the simple password, and the stored random salt value to be used as feeds in generating a complex password

2. The method according to claim 1, wherein the user's first information is the name of an application requiring a login.

3. The method according to claim 1, wherein the user's first information is the name of a website requiring a login.

4. The method according to claim 1, further comprising the password interposer program displaying the complex password on the user's device which is to be used as part of a login procedure.

5. The method according to claim 4, wherein the displaying of the complex password is based on a cryptographic program using base64 encoding.

6. The method according to claim 4, wherein the displaying of the complex password is based on a password based key derivation function using BinHex encoding.

7. A system comprising:
one or more processors, one or more computer-readable memories and one or more computer-readable, tangible storage devices;
a user device operatively coupled to at least one of the one or more storage devices for execution by at least one of the one or more processors via at least one of the one or more memories, configured to receive password interposer instructions to form a password interposer program;
an initiation module operatively coupled to at least one of the one or more storage devices for execution by at least one of the one or more processors via at least one of the one or more memories, configured to run a first time setup for the password interposer program within the user device to create a random salt value after password interposer instructions initiation and store the random salt value within the user device;
a prompting module operatively coupled to at least one of the one or more storage devices for execution by at least one of the one or more processors via at least one of the one or more memories, configured to have the user device prompt a user to enter first information and a simple password; and
a concatenating module operatively coupled to at least one of the one or more storage devices for execution by at least one of the one or more processors via at least one of the one or more memories, configured to concatenate the use of the user's first information and the simple password, and the stored random salt value to be used as feeds in generating a complex password

8. The system according to claim 7, wherein the user's first information is the name of an application requiring a login.

9. The system according to claim 7, wherein the user's first information is the name of a website requiring a login.

10. The system according to claim 7, further comprising the password interposer program displaying the complex password on the user's device which is to be used as part of a login procedure.

11. The system according to claim 10, wherein the displaying of the complex password is based on a cryptographic program using base64 encoding.

12. The system according to claim 10, wherein the displaying of the complex password is based on a password based key derivation function using BinHex encoding.

13. A computer program product comprising:
one or more computer-readable storage medium, wherein the computer readable storage medium is not a transitory signal per se;
program instructions, stored on at least one of the one or more storage medium, to cause a user device receive password interposer instructions to form a password interposer program;
program instructions, stored on at least one of the one or more storage medium, to initiate a first time setup for the password interposer program within the user device to create a random salt value after password interposer instructions initiation and store the random salt value within the user device;
program instructions, stored on at least one of the one or more storage medium, to prompt a user to enter first information and a simple password; and
program instructions, stored on at least one of the one or more storage medium, to cause the password interposer program to concatenate the use of the user's first information and the simple password, and the stored random salt value to be used as feeds in generating a complex password.

14. The computer program product according to claim 13, wherein the user's first information is the name of an application requiring a login.

15. The computer program product according to claim 13, wherein the user's first information is the name of a website requiring a login.

16. The computer program product according to claim 13, further comprising program instructions, stored on at least one of the one or more storage medium, to cause the password interposer program to display the complex password on the user's device which is to be used as part of a login procedure.

17. The computer program product according to claim 16, wherein the displaying of the complex password is based on a cryptographic program using base64 encoding.

18. The computer program product according to claim 16, wherein the displaying of the complex password is based on a password based key derivation function using BinHex encoding.
